(19) United States
(12) Patent Application Publication
(10) Pub. No.: US 2004/0104208 A1
(43) Pub. Date: Jun. 3, 2004

(54) Laser machining apparatus

(76) Inventors: Kenichi Ijima, Tokyo (JP); Tadashi Kuriowa, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/432,289

(22) PCT Filed: Mar. 28, 2002
(86) PCT No.: PCT/JP02/03088

(51) Int. Cl. B23K 26/067; B23K 26/06

(52) U.S. Cl. 219/121.77; 219/121.73; 219/121.83

(57) ABSTRACT

In a laser machining apparatus in which one laser beam is split into two laser beams by first polarizing means, one of the laser beams propagates by way of a mirror, another laser beam is scanned in two axial directions by a first galvanoscanner, and the two laser beams are guided to second polarizing means and then scanned by a second galvanoscanner to process a workpiece, an optical path is configured so that the laser beam which is transmitted through the first polarizing means is reflected by the second polarizing means, and the laser beam which is reflected by the first polarizing means is transmitted through the second polarizing means.

### TECHNICAL FIELD

The present invention relates to a laser machining apparatus which is primarily intended to perform a boring process on a workpiece such as a printed circuit board, and to improvement of the productivity of such a process.

### BACKGROUND ART

FIG. 6 is a schematic diagram of a usual laser machining apparatus for a boring process in a conventional art.

In the figure, 31 denotes a workpiece such as a printed circuit board, 32 denotes a laser beam which is used for performing a process of forming a hole such as a via hole or a through hole in the workpiece 31, 33 denotes a laser oscillator which generates the laser beam 32, 34 denotes a plurality of mirrors which reflect the laser beam 32 to guide the beam along an optical path, 35 and 36 denote galvanoscanners which scan the laser beam 32, 37 denotes an fθ lens which converges the laser beam 32 on the workpiece 31, and 38 denotes an XY stage which moves the workpiece 31.

In the usual laser machining apparatus for a boring process, the laser beam 32 which is oscillated from the laser oscillator 33 is guided to the galvanoscanners 35, 36 via a required mask and the mirrors 34. The laser beam 32 is converged on a predetermined position of the workpiece 31 via the fθ lens 37 by controlling the swing angles of the galvanoscanners 35, 36.

The swing angle of the galvanoscanners 35, 36 via the fθ lens 37 is limited to, for example, a 50 mm square. In the control of the convergence of the laser beam 32 on a predetermined position of the workpiece 31, therefore, also the XY stage 38 is controlled, so that the workpiece 31 can be processed in wider range.

Usually, the productivity of a laser machining apparatus is closely related to the driving speeds of the galvanoscanners 35, 36 and the process area of the fθ lens 37.

A configuration in which the swing angle of a galvanoscanner is reduced while maintaining the process range can be realized by conducting a change in the optical design such as a change in positional relationship between an fθ lens and the galvanoscanner. However, this involves a change in the specification of the fθ lens which requires the longest time in deign, and which is very expensive, and also that in the design of the whole optical system. As a result, it is difficult to improve economically and easily the productivity of a single beam system.

As a laser machining apparatus which is intended to improve the productivity of the above-mentioned system, is disclosed, for example, in JP-A-11-314188.

FIG. 7 is a schematic diagram of a laser machining apparatus shown in JP-A-11-314188.

In the figure, 39 denotes a workpiece, 40 denotes a mask, 41 denotes a half mirror which splits a laser beam, 42 denotes a dichroic mirror, 43a denotes a laser beam which is reflected by the half mirror, 43b denotes a laser beam which is transmitted through the half mirror and then reflected by the dichroic mirror, 44 and 45 denotes mirrors, 46 denotes an fθ lens which converges the laser beams 43a, 43b on the workpiece 39, 47 and 48 denote galvanoscanners which guide the laser beam 43a to a process area A1, 49 and 50 denote galvanoscanners which guide the laser beam 43b to a process area A2, and 51 denotes an XY stage which moves portions of the workpiece to the process area A1 or A2.

In the laser machining apparatus shown in FIG. 7, the laser beam which is transmitted through the mask 40 is split into plural beams by way of the half mirror 41, and the split laser beams 43a, 43b are guided to the plural galvanoscanner systems which are placed on the incident side of the fθ lens 46, respectively, and scanned by the plural galvanoscanner systems, thereby allowing the beams to be impinged on the process areas A1, A2 which are set in a split manner.

The split laser beam 43a is guided onto a half region of the fθ lens 46 by way of the first galvanoscanner system 47, 48.

The other split laser beam 43b is guided onto the other half region of the fθ lens 46 by way of the second galvanoscanner system 49, 50, and the first and second galvanoscanner systems are placed symmetrically with respect to the center axis of the fθ lens 46, whereby the two halves of the fθ lens 46 are simultaneously used so that the productivity can be improved.

However, the machine disclosed in JP-A 11-314188 has the configuration in which the plural laser beams which have been split by way of the half mirror 41 are scanned by the first galvanoscanner system 47, 48 and the second galvanoscanner system 49, 50, respectively, and impinged on the process areas A1, A2 which are set in a split manner. Among the laser beams 43a, 43b which are split by the half mirror 41, therefore, dispersion in laser beam quality due to difference between reflection by and transmission through the half mirror 41 easily occurs. In the case where the energies are different from each other as a result of the beam split, further expensive optical components are required in order to equalize the energies.

The optical path configuration shown in FIG. 7 has another problem in that the optical path lengths elongating from the passing of the mask 40 of the split laser beams 43a, 43b to the impinging on the workpiece 39 are different from each other and also the strict diameters of the beam spots on the workpiece 39 are different from each other.

The fθ lens 46 is equally divided, and the process areas A1, A2 which are set in a split manner are simultaneously processed. In a case such as that where holes to be formed respectively in the process areas A1, A2 are largely different in number from each other, or where one of the process areas A1, A2 is for example an end portion of the workpiece and no hole to be formed exists in the process area, therefore, it is not expected to improve the productivity.

### DISCLOSURE OF THE INVENTION

The invention has been conducted in order to solve the problems. It is an object of the invention to provide a laser machining apparatus in which differences in energy and quality of split laser beams can be minimized, the beam spot diameters can be made equal to each other by equalizing the optical path lengths of the beams, and the productivity is economically improved by causing the split laser beams to impinge on the same region.

It is an object of the invention to provide a laser machining apparatus in which the energies of split laser beams can be uniformalized by a simple adjustment, and the process performance can be further stabilized.

In order to attain the objects, according to a first aspect, in a laser machining apparatus in which one laser beam is split into two laser beams by first polarizing means, one of the laser beams propagates by way of a mirror, another laser beam is scanned in two axial directions by a first galvanoscanner, and the two laser beams are guided to second polarizing means and then scanned by a second galvanoscanner to process a workpiece, an optical path is configured so that the laser beam which is transmitted through the first polarizing means is reflected by the second polarizing means, and the laser beam which is reflected by the first polarizing means is transmitted through the second polarizing means.

Reflective surfaces of the two polarizing means are placed to be opposed to each other, and optical paths in which optical path lengths of the split laser beams are equal to each other are formed.

Third polarization angle adjusting polarizing means which is adjustable in angle is placed in front of the first polarizing means.

A sensor which can measure an energy of a laser beam is disposed, energies of the two laser beams are measured, and the angle of the third deflection angle adjusting changing means is adjusted to allow the two laser beams to be output with energies at a predetermined ratio.

### BRIEF DESCRIPTION OF THE DRAWINGS

FIG. 1 is a view showing a schematic configuration of a laser machining apparatus of the embodiment.

FIG. 2 is a beam split diagram of a polarization beam splitter.

FIG. 3 is a view schematically showing an optical path configuration of a laser machining apparatus of another embodiment.

FIG. 4 is an enlarged view of a portion of a polarization beam splitter for adjusting a polarization angle.

FIG. 5 is a flowchart of an automatic adjustment program for the polarization beam splitter for adjusting a polarization angle.

FIG. 6 is a view showing a schematic configuration of a usual laser machining apparatus for a boring process in a conventional art.

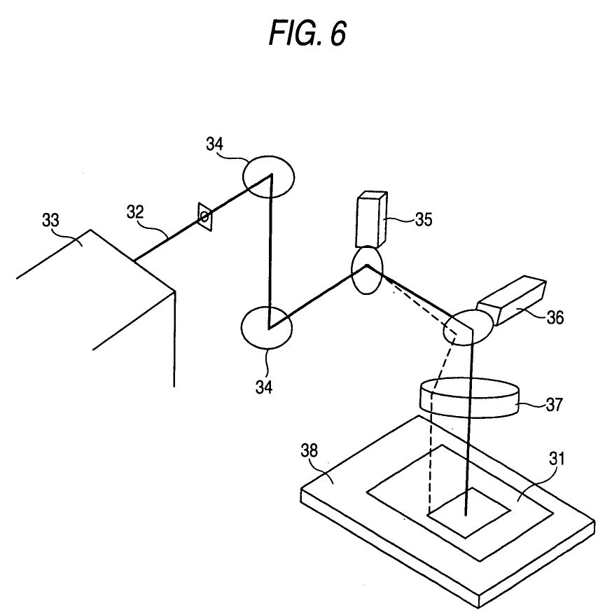

FIG. 7 is a view showing a schematic configuration of a laser machining apparatus for a boring process in a conventional art which is intended to improve the productivity.

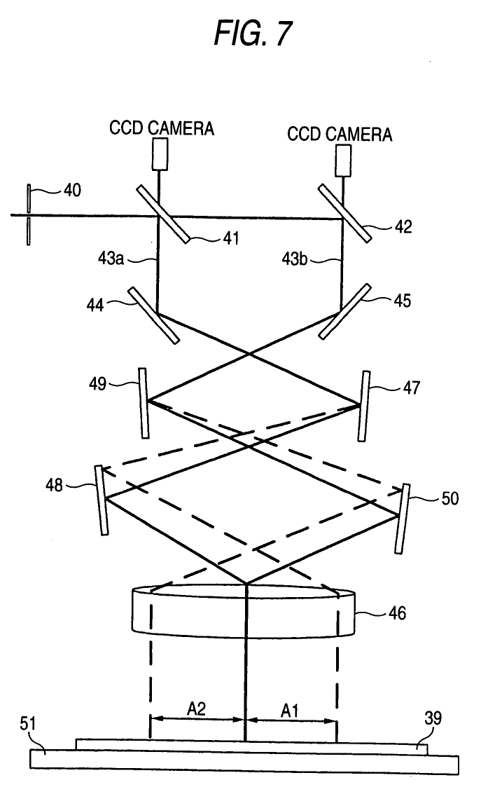

### BEST MODE FOR CARRYING OUT THE INVENTION

### EMBODIMENT 1

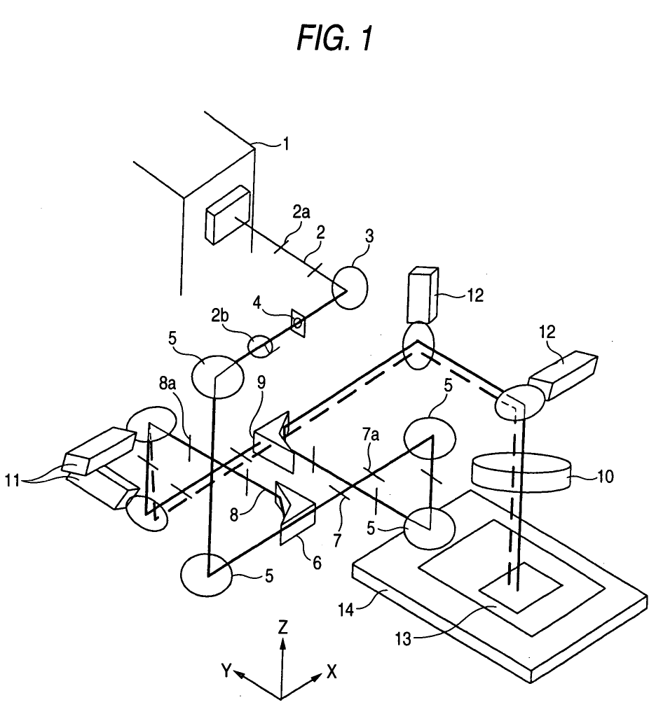

FIG. 1 is a schematic diagram showing a laser machining apparatus for a boring process in which one laser beam is split into two laser beams by a splitting polarization beam splitter, and the two laser beams are independently scanned, whereby two places can be simultaneously processed.

In the figure, 1 denotes a laser oscillator, 2 denotes a laser beam, 2a denotes the polarization direction of the laser beam 2 which has not yet been incident on a retarder 3, 2b denotes the polarization direction of the laser beam 2 which has been reflected by the retarder 3, 3 denotes the retarder which converts a linearly polarized laser beam to a circularly polarized laser beam, 4 denotes a mask which cuts away a required portion of the incident laser beam in order to obtain a processed hole of a desired size and a desired shape, 5 denotes a plurality of mirrors which reflect the laser beam 2 to guide the beam along an optical path, 6 denotes a first polarization beam splitter which splits the laser beam 2 into two laser beams, 7 denotes one of the laser beams which are split in the first polarization beam splitter 6, 7a denotes the polarization direction of the laser beam 7, 8 denotes the other one of the laser beams which are split in the first polarization beam splitter, 8a denotes the polarization direction of the laser beam 8, 9 denotes a second polarization beam splitter which guides the laser beam 7 and the laser beam 8 to a galvanoscanner 12, 10 denotes an fθ lens which converges the laser beams 7, 8 on a workpiece 13, 11 denotes a first galvanoscanner which scans the laser beam 8 in two axial directions to guide the beam to the second polarization beam splitter, 12 denotes the second galvanoscanner which scans the laser beam 7 and the laser beam 8 in two axial directions to guide the beams to the workpiece 13, 13 denotes the workpiece, and 14 denotes an XY stage which moves the workpiece 13.

Next, the detailed operation of the embodiment will be described.

As shown in the embodiment, in the laser machining apparatus for a boring process in which one laser beam is split into two laser beams by the splitting polarization beam splitter and the two laser beams are independently scanned to enable two places to be simultaneously processed, the laser beam 2 which is oscillated in the form of linearly polarized light by the laser oscillator 1 is converted to a circularly polarized laser beam by the retarder 3 which is placed in the middle of the optical path. The laser beam is then guided to the first polarization beam splitter 6 via the mask 4 and the mirrors 5. In the laser beam 2 which is incident in the form of circularly polarized light on the first polarization beam splitter 6, the P-wave component is transmitted through the polarization beam splitter 6 to be formed as the laser beam 7, and the S-wave component is reflected by the polarization beam splitter 6 to be split into the laser beam 8.

Since circularly polarized light has uniform polarized components in all directions, the laser beam 7 and the laser beam 8 are split so as to have the same energy.

The laser beam 7 which is transmitted through the first polarization beam splitter 6 is guided to the second polarization beam splitter 9 via the bend mirrors 5.

On the other hand, the laser beam 8 which is reflected by the first polarization beam splitter 6 is scanned in two axial directions by the first galvanoscanner 11, and then guided to the second polarization beam splitter 9.

Although the laser beam 7 is always guided at the same position to the second polarization beam splitter 9, the position and angle at which the laser beam 8 is incident on the second polarization beam splitter 9 can be adjusted by controlling the swing angle of the first galvanoscanner 11.

Thereafter, the laser beams 7, 8 are scanned in two axial directions by the second galvanoscanner 12, and then guided to the fθ lens 10 to be converged on predetermined positions of the workpiece 13, respectively.

At this time, when the first galvanoscanner 11 is scanned, the laser beam 8 can be impinged on the same position on the workpiece 13 as the laser beam 7.

When, for example, the galvanoscanner 11 is scanned to an arbitrary position with respect to the laser beam 7 within a preset range, the laser beam 8 can be scanned in a 4 mm square range about the laser beam 7 in consideration of the characteristics of the window of the beam splitter, and the laser beams can be impinged on different arbitrary two points on the workpiece 13 via the second galvanoscanner 12 which swings in a processable range such as a 50 mm square.

The embodiment is configured so that the laser beam 8 which is reflected by the first polarization beam splitter 6 is transmitted through the second polarization beam splitter 9, and the laser beam 7 which is transmitted through the first polarization beam splitter 6 is reflected by the second polarization beam splitter 9.

Therefore, each of the split two laser beams undergoes both the processes of reflection and transmission, and hence dispersions in quality of the laser beams and unbalanced energies due to the difference between reflection and transmission can be offset each other.

The quality of each of processed holes which are processed in the workpiece 13 by the laser beam 7 and the laser beam 8 largely depends on the energies of the laser beams.

When holes of the same quality are to be processed in the workpiece 13 by the laser beam 7 and the laser beam 8, the laser beam 7 and the laser beam 8 must have the same energy.

In the embodiment, with using the first polarization beam splitter 6 which splits the laser beam 2 into the laser beam 7 and the laser beam 8, therefore, the P wave is transmitted, and the S wave is reflected, whereby the laser beam is split into two laser beams.

A laser beam having uniform P-wave and S-wave components must be incident on the first polarization beam splitter 6.

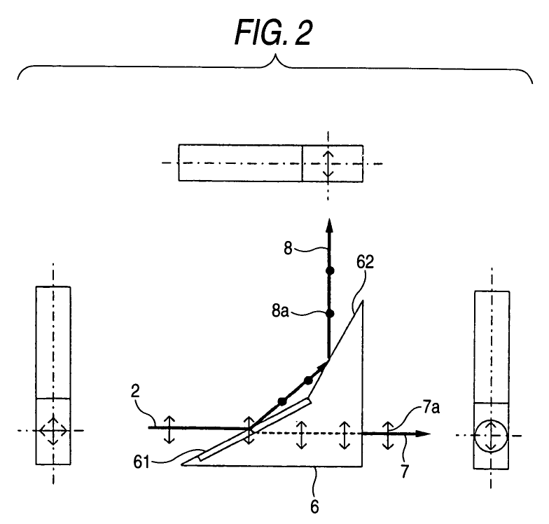

In FIG. 2, a front view of the first polarization beam splitter 6 is in the center, side views are on the right and left sides of the front view, and a plan view is on the upper side.

In the figure, 61 denotes a window portion of the polarization beam splitter. In the case of a carbon dioxide laser, ZnSe or Ge is used in the portion. The reference numeral 62 denotes a mirror for turning by 90° the laser beam reflected by the window portion 61.

A laser beam incident on the polarization beam splitter 6 has characteristics that the component (the P-wave component) in the polarization direction 7a is transmitted, and that (the S-wave component) in the polarization direction 8a is reflected.

The polarization directions of the P wave and the S wave are perpendicular to each other.

When the polarization direction of the incident laser beam is identical with the polarization direction 7a (the P-wave component), consequently, all of the laser beam is transmitted, and, when the polarization direction is identical with the polarization direction 8a (the S-wave component), all of the laser beam is reflected.

In the case of circularly polarized light in which all polarization directions uniformly exist, or a polarization direction which forms 45° with respect to the P wave and the S wave, the laser beam is equally split, and the laser beam 7 and the laser beam 8 have the same energy.

In the embodiment, the two polarization beam splitters are placed as shown in FIG. 1, whereby the optical path lengths of the laser beams 8 and 7 between the first polarization beam splitter 6 and the second polarization beam splitter 9 are made identical with each other. Therefore, the beam spot diameters of the two split laser beams can be made identical with each other.

In the embodiment, even when the optical path is resolved into the X, Y, and Z directions, for example, the same optical path lengths are obtained in all the directions. Even when the size design of components constituting the optical path is changed, therefore, the optical path can be extended or contracted in the X, Y, and Z directions, and hence the optical path lengths of the laser beams 8 and 7 can be maintained identical with each other.

### EMBODIMENT 2

In Embodiment 1 described above, the laser beam 2 oscillated from the laser oscillator 1 must be incident at an angle at which the incident light and the reflected light form 90° in the retarder 3, and the polarization direction 2a of the laser beam 2 must be incident in the retarder 3 at an angle of 45° with respect to the line of intersection of a plane in which the incident optical axis and the reflective optical axis constitute two edges, and the reflective surface of the retarder 3.

If it is assumed that the incident polarization direction of the laser beam 2 with respect to the retarder 3, and the optical axis angle are insufficiently adjusted, the circular polarization degree is lowered, and the balance between the P-wave component and S-wave component of the laser beam 2 incident on the first polarization beam splitter 6 is lost, so that the energies of the laser beam 7 and the laser beam 8 are not uniform. The polarization direction cannot be visually recognized, and, in the case of invisible light such as a carbon dioxide laser, also the optical axis angle cannot be visually recognized. In the adjustment of the polarization direction and the optical axis angle when the laser beam 2 is incident on the retarder 3, therefore, a step of measuring the circular polarization degree, and that of, if it is insufficient, adjusting the angle must be repeatedly conducted. Consequently, the adjustment sometimes requires very cumbersome works.

Between the process in which the laser beam 2 is converted into circularly polarized light 2b and that in which the circularly polarized laser beam is then incident on the first polarization beam splitter 6, the laser beam is reflected by the plurality of mirrors 5. When the laser beam is reflected by the mirrors 5, the circular polarization degree is sometimes lowered.

In the embodiment, therefore, the case where circularly polarized light is not used and a laser beam which is oscillated in the form of linearly polarized light is used will be described.

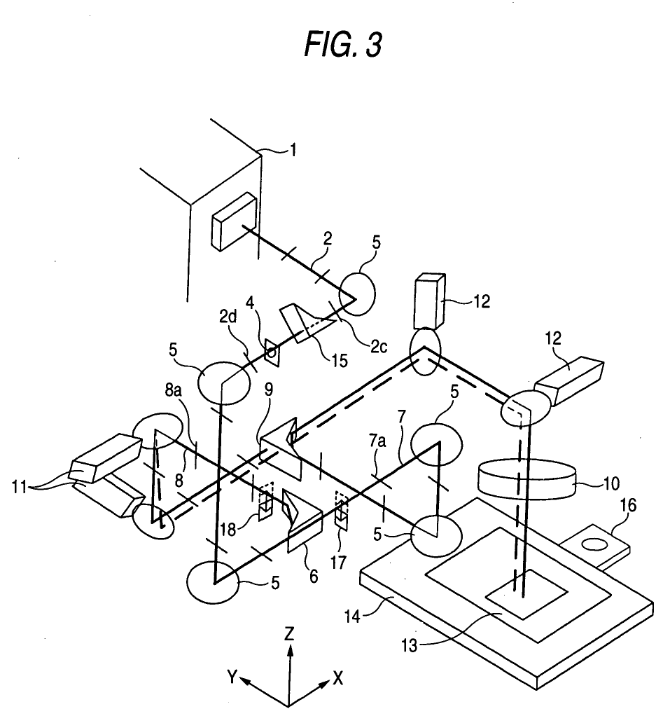

FIG. 3 is a schematic diagram showing a laser machining apparatus of an embodiment of the invention.

In the figure, 2c denotes the polarization direction of the laser beam 2 which has not yet been incident on a third polarization beam splitter 15, 2d denotes the polarization direction of the laser beam 2 which has been transmitted through the third polarization beam splitter 15, 15 denotes the third polarization beam splitter which adjusts the polarization direction of the laser beam 2, 16 denotes a power sensor which measures the energy of the laser beam emitted from the fθ lens 10, 17 denotes a first shutter which intercepts the laser beam 7, and 18 denotes a second shutter which intercepts the laser beam 8.

The power sensor 16 is fixed to the XY table 14. When the energy of a laser beam is to be measured, the power sensor 16 can be moved to a position where the laser beam strikes a light receiving portion of the power sensor 16.

The other reference numerals are identical those of FIG. 1 which has been described in Embodiment 1, and hence the description is omitted.

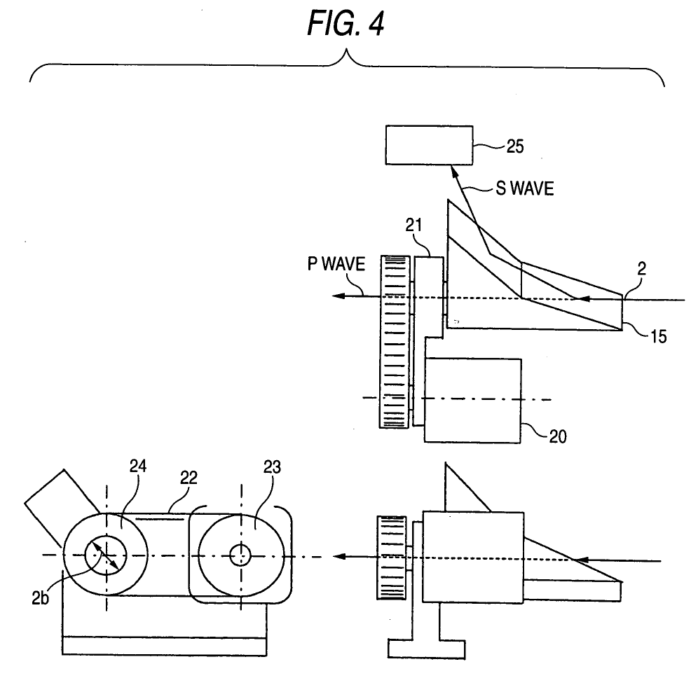

FIG. 4 is a detail view of the third polarization beam splitter 15 shown in FIG. 3.

In the figure, 20 denotes a servomotor, 21 denotes a bracket which fixes the third polarization beam splitter 15 and the servomotor 20, 22 denotes a timing belt which transmits the power of the servomotor 20 to the third polarization beam splitter 15, 23 denotes a first pulley which is attached to the servomotor 20 to transmit the power of the servomotor 20 to the timing belt 22, 24 denotes a second pulley which is attached to the third polarization beam splitter 15, and which is rotated by the timing belt 22, and 25 denotes a damper which receives the S-wave component of the laser beam 2 which is reflected by the third polarization beam splitter 15.

The laser beam 2 is oscillated in the form of the linearly polarized light 2c by the laser oscillator 1, reflected by the mirrors 5, and then guided to the third polarization beam splitter 15.

The P-wave component of the laser beam 2 is transmitted through the third polarization beam splitter 15 to change the polarization direction to the linearly polarized light 2d which is different in angle from the linearly polarized light 2c, and then guided to the mask 4.

The S-wave component of the laser beam 2 is reflected by the third polarization beam splitter 15, and then absorbed by the damper 25.

The laser beam 2 in which only a desired portion is transmitted through the mask 4 is reflected by the mirrors 5, and then guided to the first polarization beam splitter 6.

In the first polarization beam splitter 6, the P-wave component of the laser beam is transmitted through the first polarization beam splitter 6 (the laser beam 7), and the S-wave component is reflected by the first polarization beam splitter 6 (the laser beam 8).

The laser beam 7 is reflected by the mirrors 5, guided to the second polarization beam splitter 9, guided to the second galvanoscanner 12 to be scanned in the X direction and the Y direction, and converged by the fθ lens 10 to process the workpiece 13 mounted on the XY table 14.

On the other hand, the laser beam 8 is scanned in the X direction and the Y direction by the first galvanoscanner 11, and then guided to the second polarization beam splitter 9.

Thereafter, the laser beam is again scanned in the X direction and the Y direction by the second galvanoscanner 12, and then converged by the fθ lens 10 to process the workpiece 13 mounted on the XY table 14.

The balance of the energies of the laser beam 7 and the laser beam 8 can be changed by changing the ratio of the P-wave component and the S-wave component which are incident on the first polarization beam splitter 6. A linearly polarized laser beam can be made incident on the first polarization beam splitter 6, by changing the polarization angle 2d of the incident laser beam 2. Setting the loss, the production error, and the like in the first polarization beam splitter 6 aside, when the laser beam 2 of the same polarization direction as the P wave is incident, all of the laser beam is transmitted as the laser beam 7, and, when the laser beam 2 of the same polarization direction as the S wave is incident, all of the laser beam is reflected as the laser beam 8.

In order to perform the splitting operation with setting the laser beam 7 and the laser beam 8 to have the same energy, the laser beam 2 is incident at a polarization angle of 45° with respect to the P wave and the S wave.

The polarization angle 2c of the laser beam 2 at the oscillation from the laser oscillator 1 is determined by the optical structure of the laser oscillator 1. Therefore, the polarization angle cannot be easily changed.

When the laser beam 2 is passed through the third polarization beam splitter 15, however, only the P-wave component is transmitted, and the S-wave component is reflected. Therefore, the polarization angle 2c of the laser beam 2 can be easily changed by changing the angle of the third polarization beam splitter 15.

Namely, when the splitting operation is to be performed with setting the laser beam 7 and the laser beam 8 to have the same energy, the angle of the third polarization beam splitter 15 is adjusted so that the laser beam 2 is incident at the polarization angle 2d of 45° with respect to the P wave and the S wave of the first polarization beam splitter 6.

An angle adjustment mechanism of the third polarization beam splitter 15 is shown in FIG. 4.

The third polarization beam splitter 15 is fixed to the bracket 21 so as to be rotatable about the optical axis of the laser beam 2. The second pulley 24 is fixed so as to be rotated together with the third polarization beam splitter 15.

Also the servomotor 20 to which the first pulley 23 is attached is fixed to the bracket 21. The second pulley 24 fixed to the third polarization beam splitter 15, and the first pulley 23 fixed to the servomotor 20 are coupled to each other by the timing belt 22.

When the servomotor 20 rotates in response to a signal from a control apparatus which is not shown in the figures, the power is transmitted to the third polarization beam splitter 15 through the timing belt 22, and the angle of the third polarization beam splitter 15 is changed. The S-wave component of the laser beam 2 which is reflected by the third polarization beam splitter 15 is received by the damper 25.

When the angle in the polarization direction is adjusted in the third polarization beam splitter 15, the S-wave component is not transmitted but lost. In order to efficiently use a laser beam, therefore, incidence is conducted so that the polarization angle 2A of the laser beam 2 in front of the third polarization beam splitter 15 is identical as much as possible with the polarization angle 2d of the laser beam 2 in rear of the third polarization beam splitter 15.

The angle adjustment of the third polarization beam splitter 15 plays a role of finely adjusting the polarization angle 2d in order to enable the laser beam 2 to be incident on the first polarization beam splitter 6 at a correct polarization angle.

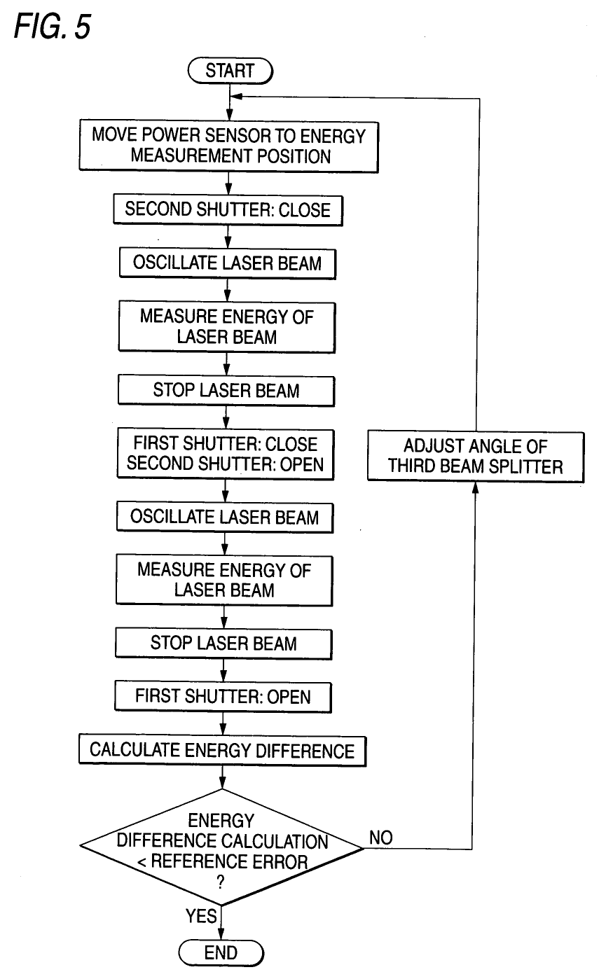

FIG. 5 shows the flow of an automatic adjustment of the angle of a polarization beam splitter for adjusting a polarization angle in order to enable two laser beams to be output at energies of a desired ratio in the embodiment of the invention.

Description will be made with reference to FIGS. 3 and 5. For the sake of convenience in description, the case where the two energies are equalized with each other will be described.

Also in the case where energies of two laser beams are at different ratios, when the initial setting is modified, the automatic adjustment can be conducted in the same manner.

An allowable energy difference between the laser beam 7 and the laser beam 8 is determined, and input to the control apparatus which is not shown in the figures, and an automatic angle adjustment program for the third polarization beam splitter 15 is implemented.

First, the power sensor 16 fixed to the XY table 14 is moved to a position where the light receiving portion of the power sensor 16 can receive the laser beam emitted from the fθ lens 10.

Thereafter, the second shutter 18 is closed, and the laser oscillator 1 oscillates a laser beam.

Since the second shutter 18 is closed, the laser beam 8 is blocked by the portion, only the laser beam 7 is emitted from the fθ lens 10, and the power sensor 16 measures the energy of the laser beam 7.

After the energy measurement, the laser beam oscillation is once stopped, the first shutter 17 is closed, the second shutter 18 is opened, and the laser beam is again oscillated. At this time, since the first shutter 17 is closed, the laser beam 7 is blocked by the portion, only the laser beam 8 is emitted from the fθ lens 10, and the power sensor 16 measures the energy of the laser beam 8. After the energy measurement, the laser beam oscillation is stopped, and the second shutter 18 is opened.

In the control apparatus, the energy difference between the two measured laser beams is calculated, and then compared with the allowable value which is initially input.

If the difference is within the allowable value, the program is ended. If the difference is not within the allowable value, the angle of the third polarization beam splitter 15 is adjusted, the energy measurement of the two laser beams is again performed, and the above-mentioned operations are repeated until the difference is within the allowable value. The adjustment amount of the angle of the third polarization beam splitter 15 depends on the polarization direction 2d of the incident laser beam 2 and the attachment angle of the first polarization beam splitter 6. In the case where the polarization angle 2d of the incident laser beam 2 which has been transmitted through the third polarization beam splitter 15 is changed by several degrees from the polarization angle 2c of the laser beam 2 which has not yet been transmitted through the third polarization beam splitter 15, it is theoretically derived that the energy difference can be adjusted by about 7% per 1° of the angle of the third polarization beam splitter 15.

In this way, the relationship between the adjustment angle of the third polarization beam splitter 15 and the energy difference of the two laser beams can be theoretically derived from the polarization angle 2d of the incident laser beam 2 and the attachment angle of the first polarization beam splitter 6. Although depending on the allowable value of the energy difference, when the allowable value is about 5%, the adjustment (program) is completed by conducting twice the above-mentioned adjustment loop. Therefore, the adjustment can be easily conducted for a short time period.

According to the embodiment, in a laser machining apparatus in which one laser beam is split into two laser beams by a splitting polarization beam splitter and the two laser beams are independently scanned to enable two places to be simultaneously processed, a polarization beam splitter for adjusting a polarization angle is set in front of the splitting polarization beam splitter so that a change of the polarization angle of a laser beam can be conducted on the P wave (transmitted wave) and the S wave (reflected wave) of the splitting polarization beam splitter, a mechanism which can adjust an angle is disposed in the polarization beam splitter for adjusting a polarization angle, and the angle adjustment is enabled in response to a command from a control apparatus. Consequently, the energy balance between the split laser beams can be easily adjusted, the process performance can be stabilized by uniformalizing the energies, shortening of the setup time can be realized, and stabilized production can be realized.

Furthermore, a sensor which can measure the energy of a laser beam is disposed, the energies of the two laser beams are measured, and the angle of the polarization beam splitter for adjusting a polarization angle can be automatically adjusted so that the two laser beams can be output at energies of a desired ratio, whereby the setup time can be further shortened. Moreover, the easy adjustment eliminates the necessity of skills of the worker, and can realize a stabilized process.

As described above, according to the invention, the quality and energy difference of split laser beams can be uniformalized, and the productivity can be improved.

The optical path lengths of two split laser beams are made identical with each other, whereby the beam spot diameters of the two split laser beams can be made identical with each other.

The energy balance between split laser beams can be easily adjusted, shortening of the setup time can be realized, and stabilized production can be realized.

A sensor which can measure the energy of a laser beam is disposed, the energies of the two laser beams are measured, and the angle of the polarization beam splitter for adjusting a polarization angle can be automatically adjusted so that the two laser beams can be output out at energies of a desired ratio, whereby the setup time can be further shortened. Moreover, the easy adjustment eliminates the necessity of skills of the worker, and can realize a stabilized process.

### Industrial Applicability

As described above, the laser machining apparatus of the invention is suitable as a laser machining apparatus which is primarily intended to perform a boring process on a workpiece such as a printed circuit board.

1. A laser machining apparatus in which one laser beam is split into two laser beams by first polarizing means, one of the laser beams propagates by way of a mirror, another laser beam is scanned in two axial directions by a first galvanoscanner, and the two laser beams are guided to second polarizing means and then scanned by a second galvanoscanner to process a workpiece, wherein an optical path is configured so that the laser beam which is transmitted through the first polarizing means is reflected by the second polarizing means, and the laser beam which is reflected by the first polarizing means is transmitted through the second polarizing means.

2. A laser machining apparatus according to claim 1, wherein reflective surfaces of the two polarizing means are placed to be opposed to each other, and optical paths in which optical path lengths of the split laser beams are equal to each other are formed.

3. A laser machining apparatus according to claim 1 or 2, wherein third polarization angle adjusting polarizing means which is adjustable in angle is placed in front of the first polarizing means.

4. A laser machining apparatus according to claim 3, wherein a sensor which can measure an energy of a laser beam is disposed, energies of the two laser beams are measured, and the angle of the third deflection angle adjusting changing means is adjusted to allow the two laser beams to be output with energies at a predetermined ratio.
